(19) United States
(12) Patent Application Publication
(10) Pub. No.: US 2014/0122996 A1
(43) Pub. Date: May 1, 2014

(54) METHOD, SYSTEM, AND PROGRAM FOR AUTOMATIC GENERATION OF SCREENS FOR MOBILE APPS BASED ON BACK-END SERVICES

(71) Applicants: Kapil Gupta, Bangalore (IN); K. R. Venkat, Bangalore (IN); Sudhir Babu, Bangalore (IN); Radhakrishna Murthy, Bangalore (IN)

(72) Inventors: Kapil Gupta, Bangalore (IN); K. R. Venkat, Bangalore (IN); Sudhir Babu, Bangalore (IN); Radhakrishna Murthy, Bangalore (IN)

(21) Appl. No.: 13/851,779

(22) Filed: Mar. 27, 2013

(30) Foreign Application Priority Data
Oct. 26, 2012 (IN) 4482/CHE/2012

(51) Int. Cl. G06F 17/22

(52) U.S. Cl. CPC G06F 17/2247
USPC 715/234

(57) ABSTRACT

The present invention enables development of a mobile app screen based on a back-end service, deploy the screen into a mobile app, and develop integration components to connect to the back-end service. The present invention enables automatic creation of a user interface based on a back-end service and offers sufficient flexibility in screen layout modification. The present invention facilitates seamless addition of that screen into a mobile app, submission of data from the screen into the back-end service, and rendering of data received from the back-end service onto the screen.

### BACKGROUND OF THE INVENTION

1. Field of the Invention

The present invention generally relates to mobile apps in smartphones, and more particularly to development of a mobile app screen based on a back-end service, and integrating that screen with the back-end service.

2. Related Art

A mobile application (or mobile “app”) is a software application designed to run on mobile devices such as smartphones. Mobile apps are available through application distribution platforms, which are typically operated by the owner of the mobile operating system. Usually, mobile apps are downloaded from the platform to a target device such as a smartphone, which can support many applications and programming languages. Mobile apps are also sometimes downloaded to less mobile computers, e.g., laptops or desktops.

A “smartphone” as used in this application includes the class of mobile phones or devices built on a mobile operating system (OS), with more advanced computing capability and connectivity than a feature phone. Smartphones typically include the functionality of, e.g., portable media players, compact digital cameras, and GPS navigation units, among others, to form one multi-use device. They also typically include high-resolution touch screens and web browsers that display standard web pages, as well as mobile-optimized sites. High-speed data access is provided by, e.g., Wi-Fi or Mobile Broadband.

Common mobile operating systems (OS) in use include but are not limited to Apple's iOS, Nokia's Symbian, RIM's BlackBerry OS, Google's Android, Samsung's Bada, Microsoft's Windows Phone, and Hewlett-Packard's webOS. Such operating systems can be installed on many different phone models, and typically each device can receive multiple OS software updates over its lifetime.

### SUMMARY OF THE INVENTION

The introduction of the “mobile app store” has revolutionized the way in which new functionality is built in the form of mobile apps and delivered to smartphones. It is estimated that there are more than a million distinct apps across all mobile app stores. These apps serve many purposes. One of them is to extend the services available in back-end systems to the mobile channel. The back-end services are typically available in different message formats and need to be integrated using various integration options. The conventional approach is to build a mobile platform specific native screen for each such service, develop a connector to integrate with the back-end service, and embed them into the mobile app. However, this approach often requires significant effort in manually building the required components. It also requires duplication of efforts for each of the leading mobile platforms viz., iOS, Android, BlackBerry, Windows, etc.

The present invention according to one aspect helps to automate development of a mobile app screen based on a back-end service, deploy the screen into a mobile app, and develop integration components to connect to the back-end service. The present invention enables automatic creation of a user interface based on a back-end service and offers sufficient flexibility in screen layout modification. The present invention facilitates seamless addition of that screen into a mobile app, submission of data from the screen into the back-end service, and rendering of data received from the back-end service onto the screen.

By virtue of the features of the present invention, as the screen is built directly based on the back-end service, any data captured in the screen can be directly submitted to the back-end without the need to either modify the payload structure or manually build integration services. Similarly, any response received from the back-end service can also be rendered to the screen without any manual intervention. Furthermore, the present invention can also provide external handlers in the mobile tier as well as the back-end tier to accommodate any other processing apart from data submission and payload rendering.

Accordingly, the present invention can significantly reduce the time required to develop a screen which needs to interact with a back-end service. Since the screen is directly built based on the back-end service, there is no need to manually verify the definition and data type of each field in the screen with the corresponding element in the underlying service. The present invention can also eliminate the need to transform/translate when data is exchanged between the screen and the back-end service, thereby simplifying the integration process. The present invention can also help to retrieve and aggregate data from multiple back-end services into one screen and also submit data from one screen to multiple back-end services. An option can also be provided to automatically upgrade a screen when the underlying service is modified.

Problems relating to the above have existed since the beginning of mobile app development. Others have of course attempted to address such problems; however, the conventional solutions have a number of drawbacks. For example, conventional approaches can be quite time consuming, suffer from increased cost, and be vulnerable to operational mistakes.

The present invention uses cross mobile platform technologies viz., HTML5, Cascading Style Sheet (CSS), and JavaScript, to build screens. The core approach followed in developing a screen is very different from the cross mobile development platforms. Instead of building a screen and then integrating with a back-end service, the process of the present invention starts with the back-end service. The process automatically creates the data model and a default layout based on the service. This ensures that the user does not have to manually create each and every element. It also eliminates the need to manually keep the screen data model in sync with the underlying service data model.

The generic container app described herein helps send data to the back-end service and render data from the back-end service without the need to develop screen-specific programs. It caters to the need to automatically source information from multiple services and display them on one screen. Similarly, it helps in submitting data from one screen into multiple services. Its ability to automatically upgrade the screen in case of any changes in the underlying service further helps in reducing the manual effort involved to keep the screen in sync with the modified back-end service.

The present invention may be for use with devices including but not limited to smartphones, iPhones, iPads, tablets, desktops, Blackberries, etc., devices with common mobile operating systems such as Apple's iOS, Nokia's Symbian, RIM's BlackBerry OS, Google's Android, Samsung's Bada, Microsoft's Windows Phone, Hewlett-Packard's webOS, etc.

Further features and advantages of the present invention, as well as the structure and operation of various embodiments of the present invention, are described in detail below with reference to the accompanying drawings.

### BRIEF DESCRIPTION OF THE DRAWINGS

The features and advantages of the present invention will be more readily understood from a detailed description of the exemplary embodiments taken in conjunction with the following figures.

FIG. 1 is a flowchart which shows the development of a new screen based on a single service, according to an aspect of the present invention.

FIG. 2 is a flowchart which shows a new mash-up screen development based on multiple services, according to an aspect of the present invention.

FIG. 3 is a flowchart which shows automatic screen upgrade, according to an aspect of the present invention.

FIG. 4 is a flowchart which shows the container app component according to an aspect of the present invention, which facilitates addition of new screens into a mobile app and enables data exchange between the mobile tier and the application server tier.

FIG. 5 is a flowchart which shows the app server component according to an aspect of the present invention, which is responsible for receiving the request from the mobile tier and sending a response to the mobile tier.

FIG. 6 shows the application development environment the present invention is operating in.

The invention will next be described in connection with certain exemplary embodiments; however, it should be clear to those skilled in the art that various modifications, additions, and subtractions can be made without departing from the spirit or scope of the claims.

### DETAILED DESCRIPTION OF THE PREFERRED EMBODIMENTS

As discussed above, the present invention is directed to methods, systems, apparatuses, and programs for automatic generation of screens for mobile apps based on back-end services. The present invention helps to automate the development of a mobile app screen based on a back-end service, and integrates that screen with the back-end service. The present invention enables automatic creation of a user interface based on the back-end service and offers sufficient flexibility to modify the screen layout. The present invention facilitates submission of data from the screen to the back-end service and rendering of data received from the back-end service onto the screen. The present invention allows “mash-up” of multiple services into one screen and automatic integration with all those services. It also simplifies the process of upgrading a screen in case the underlying service is modified.

The present invention comprises a mobile app development environment that is used to develop screens based on back-end services. For every screen, the mobile app development environment stores the screen definition in Extensible Markup Language (XML) format and creates a HyperText Markup Language (HTML) page, a Java Script Object Notification (JSON) file, and a JavaScript file, which are to be included as part of an app in the mobile tier. If the integration preference is chosen as Indirect, then a back-end Java program is created that is used to interface with the back-end service.

The present invention also comprises platform specific mobile app containers that are used to include the front-end screen specific files generated by the development environment, and app server components that are used to route requests from the mobile tier to the relevant back-end system. The containers provide access to the native functionality of each platform. They also include JavaScript functions that enable exchange of data between the mobile tier and the back-end application tier.

There are already some mobile development platforms that provide an option to generate screens that are mobile operating system independent. However, none of these platforms provide an option to directly download a XSD or JSON and build a screen automatically as with the present invention. The screen needs to be developed from scratch using the widgets provided by the platform.

Once a screen that needs to be packaged into a mobile is developed, there are some platforms that provide an option to include the screen into the app. However, those platforms do not provide the option to exchange data between the mobile tier and the application server tier automatically. The generic java script based services built as part of the present invention allow such communication without having the need to build specific data exchange handlers for each screen.

To connect to a back-end service from the mobile tier, the normal approach is to manually build the integration component based on the data received from the mobile tier. Since the present invention creates the screen directly based on the service, the data received will conform to the format. This enables direct passage of data to the back-end without any transformation. In addition, the back-end RESTful web service built by the development will allow automatic conversion from JSON to XML and vice-versa, thereby further eliminating the need to perform any data transformation changes.

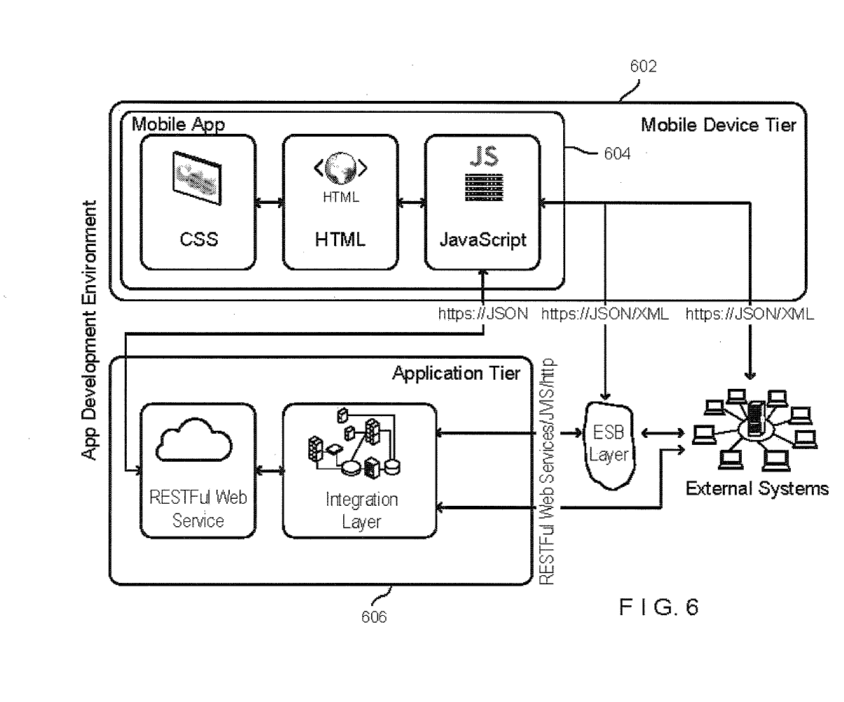

FIG. 6 shows the application development environment the present invention is operating in, e.g., a mobile device tier 602 (carries out functions such as screen loading, etc.) with the mobile app 604, as well as an application tier 606 (carries out functions such as converting requests to action, etc.) which communicate with external systems. A description of the role of the various components of the present invention is as follows.

### Development Tool

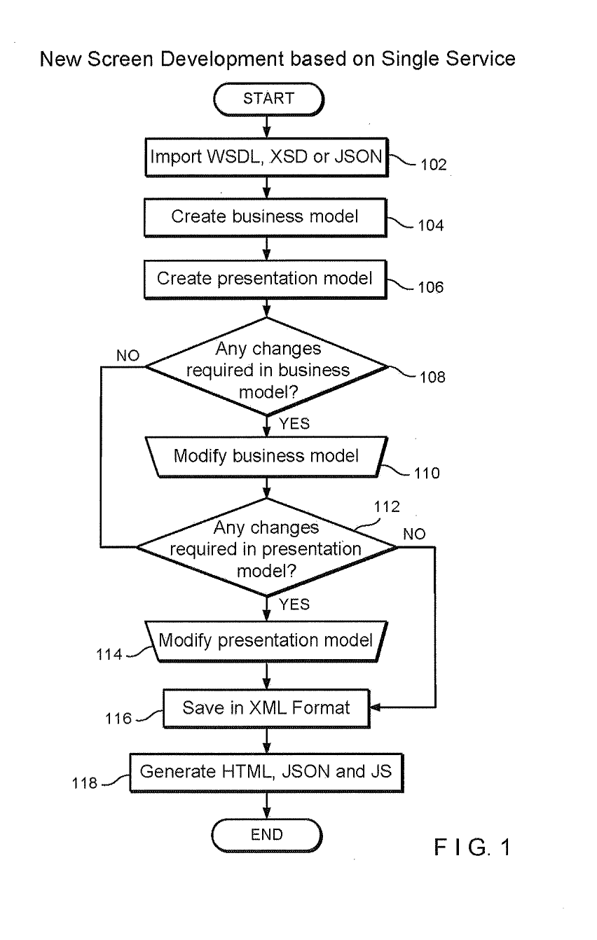

FIG. 1 shows a method according to the present invention for use by the Development Tool for enabling screen development based on a back-end service. The Development Tool can be a module located in, e.g., the Application Tier of FIG. 6. This tool or development environment provides an option to import the message format definition associated with the back-end service. This message format definition can be in the form of a Web Service Definition Language (WSDL), a XML Schema Definition (XSD), or a Java Script Object Notification (JSON) schema. For this, a Java program is written to parse using, e.g., the Xerces parser in case the message format is either WSDL or XSD, or the JSON parser in case the message format is JSON. These parsers extract nodes, elements, annotations, enumerations, data restrictions, etc., available in the message format definition. Once the details are extracted or the message format is imported (step 102), a business model is automatically created (step 104) as per the following rules.

Create a block for every node in the format definition. In case there is any annotation included for a node, associate the same with the corresponding block.

In case of master-detail relation between two nodes, define the parent node for the child node along with the type of relation viz., one to one or one to many.

Create a field for every element in the format definition. In case there are any attributes defined with the element such as data type, data length, minimum occurrences, maximum occurrences, enumeration values, annotation, default value, etc., associate those attributes with the field.

Once the business model is created (step 104), the tool will then build a presentation model (step 106). The presentation model is a default layout which is created as per the following rules.

Create a default window which will be used to display all nodes and elements.

Create a field group for each node. This field group consists of all elements under that node, and each element display type is chosen as Text Box, List Item, Check Box, etc., based on the element properties.

In case a node can have only one record, then define the view property of the corresponding field group as form, so that all elements are shown in a single record format. In case a node can have multiple records, then define the view property of the corresponding field group as grid, so that records are shown in multi-record tabular form.

If there is a master-detail relation between two nodes, then define that relation between the corresponding field groups.

The default business model (step 104) and the presentation model (step 106) created above are used to create a Hyper Text Markup Language (HTML) page, a JSON file, and a JavaScript (JS) file. The HTML page is created based on HTML5 standards and contains all presentation-related attributes of the screen. The JSON file includes the hierarchy definition of various nodes and these details will be used to retrieve data from the screen and render data received from the back-end service. The JS file provides the developer with an option to include functions that can be invoked when a specific action is performed on the screen. This JS file is created for the first time when a screen is created. After that, any changes are done directly in the JS file and it is not regenerated by the tool. The HTML file will have a provision to include external files like jquery-mobile java script, jquery-mobile Cascading Style Sheet (CSS), as well as other java script and CSS files for maximum flexibility in screen definition.

Once the default business model and presentation model are created, the tool displays them to the developer and allows modifications (steps 108, 110, 112, 114). As part of modifications, the user is provided with a number of options as explained below, including:

Change field display view property.

Change field group display view property.

Define the number validations, string validations, and list validations.

Bind a function at an element level event.

Bind a function at a screen level event.

Rearrange the sequence of field groups.

Rearrange the order of elements.

Create new windows that can be accessed as part of the drill-down operation.

Create new control elements.

Hide existing elements.

Once the modifications are completed, the tool stores the business model and the presentation model in, e.g., Extensible Markup Language (XML) format (step 116). This XML will act as the source file and can be loaded into the tool at a later time to incorporate further changes, if required.

Apart from the above options, the tool also provides an option to define a completely different layout which can be used for specific mobile form factors. In such cases, the tool will generate as many HTML files as the number of layouts. However, JSON and JS files will remain the same as the business model remains unchanged. HTML, JSON, and JS files can be generated (step 118), and depending on the target mobile platform, the relevant HTML file along with the common JSON and JS file can be packaged and deployed.

### New Mash-Up Screen Development Based on Multiple Services

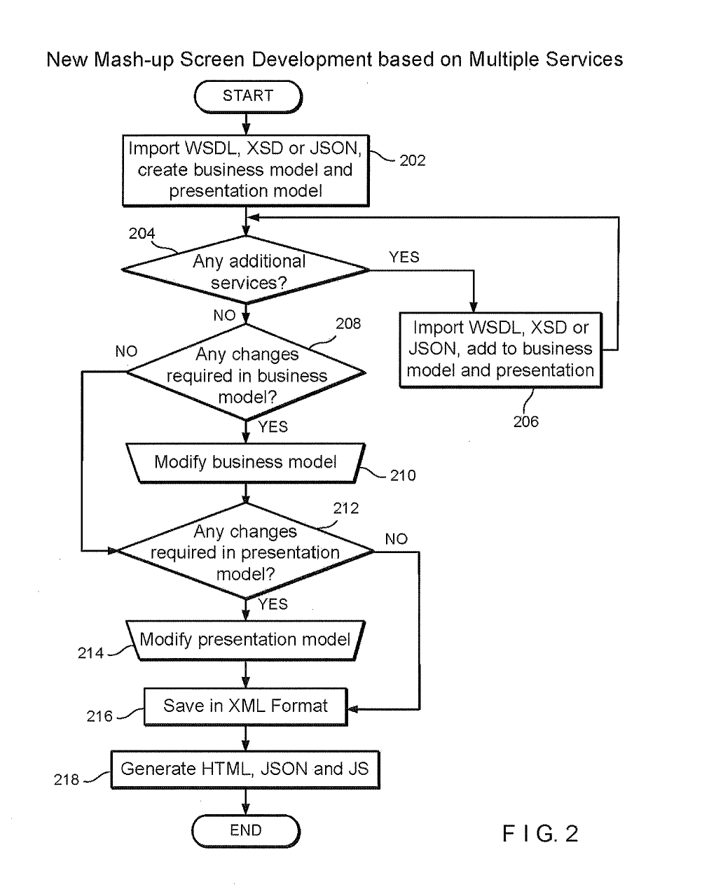

Sometimes a screen needs to interact with multiple back-end services to fetch and display data. In some cases, a screen may need to submit data to multiple services in the back-end. The present invention provides a development environment to automate the development of such screens and integration with the relevant back-end services as shown in the flowchart of FIG. 2. The new mash-up screen development tool can be a module located in, e.g., the Application Tier of FIG. 6.

The development environment can be used to import any one service to begin with. For this, the same procedure as explained in the previous section regarding the Development Tool (FIG. 1) can be followed. The development environment will additionally make sure that each block created in this case is associated with the service using which they are created.

Once the data model and a default presentation layout are created (step 202), another service can be imported into the same screen (step 204). The message definition format of this service need not be same as the message definition format of the first service. It can be a Web Service Definition Language (WSDL), a XML Schema Definition (XSD), or a Java Script Object Notification (JSON) schema. In case the message format is either WSDL or XSD, then a Xerces parser is used to extract nodes, elements, annotations, enumerations, data restrictions, etc., available in the definition. In case the message format is JSON, then a JSON parser is used to extract similar information from the definition. Once the details are extracted, it automatically adds to the existing business model (step 206) as per the following rules:

Create a block for every node in the format definition and associate it with the service. Before creation, validate that the same block is not already present as part of another service data model. If the same block is already present, then add a suffix to the block and then create it. In case there is any annotation included for the node, associate the same with the corresponding block.

In the case of a master-detail relation between two nodes, define the parent node for the child node along with the type of relation viz., one to one or one to many.

Create a field for every element in the format definition. In case there are any attributes defined with the element such as data type, data length, minimum occurrences, maximum occurrences, enumeration values, annotation, default value, etc., associate those attributes with the field.

Once the business model is created, the tool will then add to the presentation model created earlier (step 206). The following rules are used while adding to the presentation model:

Create a field group for each node. This field group consists of all elements under that node and each element display type is chosen as Text Box, List Item, Check Box, etc., based on the element properties.

In case a node can have only one record, define the view property of the corresponding field group as form, so that all elements are shown in a single record format. In case a node can have multiple records, then define the view property of the corresponding field group as grid, so that records are shown in multi-record tabular form.

If there is a master-detail relation between two nodes, then define that relation between the corresponding field groups.

The above procedure is repeated until all relevant services are imported into the screen. After that, the business model and the presentation model are used to create a Hyper Text Markup Language (HTML) page, a JSON file, and a JavaScript (JS) file. The HTML page is created based on HTML5 standards and contains all presentation-related attributes of the screen. The JSON file includes the hierarchy definition of various nodes, and these details will be used to retrieve data from the screen and render data received from the back-end service. The JS file provides the developer with an option to include functions that can be invoked when a specific action is performed on the screen. This JS file is created for the first time when a screen is created. After that, any changes are done directly in the JS file and it is not regenerated by the tool. The HTML file will have a provision to include external files such as jquery-mobile java script and jquery-mobile Cascading Style Sheet (CSS), as well as other java script and CSS files for maximum flexibility in screen definition.

Once the default business model and presentation model are created, the development environment displays the layout to the developer and allows modifications (steps 208, 210, 212, 214). As part of modifications, the user is provided with a number of options as explained below:

Change field display view property.

Change field group display view property.

Define number validations, string validations, and list validations.

Bind a function at an element level event.

Bind a function at a screen level event.

Rearrange the sequence of field groups.

Rearrange the order of elements.

Create new windows that can be accessed as part of the drill-down operation.

Create new control elements.

Hide existing elements.

Once the modifications are completed, the tool stores the business model and the presentation model in Extensible Markup Language (XML) format (step 216). This XML will act as the source file and can be loaded into the tool at a later time to incorporate further changes, if required.

Apart from the above options, the tool also provides an option to define a completely different layout which can be used for specific mobile form factors. In such cases, the tool will generate as many HTML files as the number of layouts. However, JSON and JS files will remain the same as the business model remains unchanged. HTML, JSON, and JS files can be generated (step 218), and depending on the target mobile platform, the relevant HTML file along with the common JSON and JS file can be packaged and deployed.

### Automatic Screen Upgrade

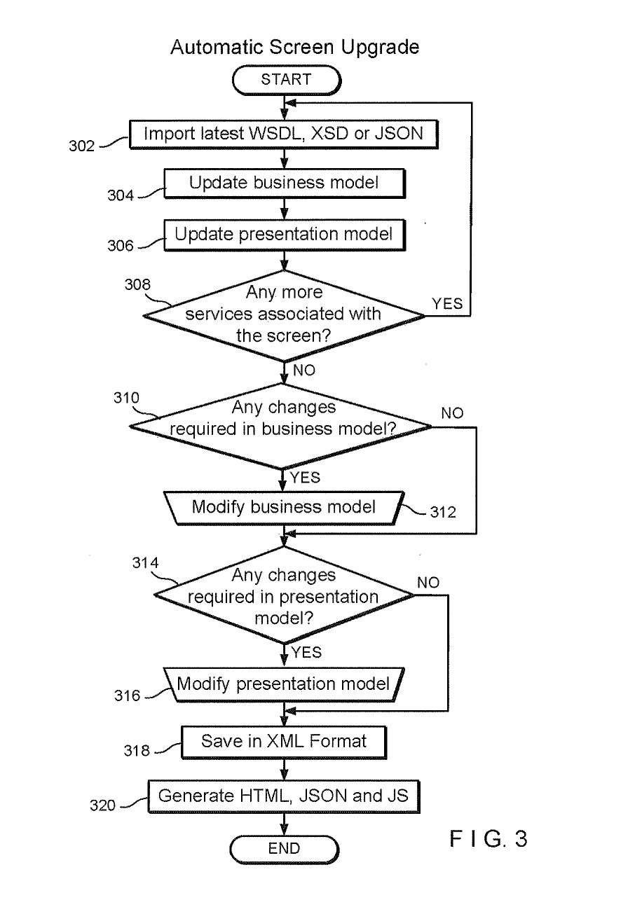

The present invention provides a development environment to automatically upgrade a screen whenever the underlying service is modified. In case a screen is built based on multiple services, then screen upgrade is facilitated whenever any of those services are modified, as shown in the flowchart of FIG. 3. The Automatic Screen Upgrade can be a module or sub-module as part of the Development Tool.

The development environment enables opening of the screen XML file consisting of the data model and presentation layouts of the screen that needs to be upgraded. It then provides an option to import the modified service (step 302). In case the screen is built using multiple services, it provides an option to all modified services in a sequential manner. The message format of the modified service need not be same as the message format of the original service as the information extracted by the development environment is similar irrespective of the message format. If the message format is either WSDL or XSD, then a Xerces parser is used to extract nodes, elements, annotations, enumerations, data restrictions, etc., available in the definition. In case the message format is JSON, then a JSON parser is used to extract similar information from the definition. Once the details are extracted, the process automatically adds to the existing business model as per the rules given below.

For every node in the format definition, verify whether it is already present in the current data model under the same service.

In case the node is not present, create a block for that node and associate it with the service. If it is a child node to another node, then associate the node with the parent node and define an appropriate relation viz., one to one or one to many. In case there is any annotation included for the node, associate the same with the corresponding block. Create a field for every element in the format definition. In case there are any attributes defined with the element such as data type, data length, minimum occurrences, maximum occurrences, enumeration values, annotation, default value, etc., associate those attributes with the field.

If the node is already present, verify whether there is any change required in the master-detail relation for that node. If it is required, update the existing master-details relation appropriately. In case there is any annotation included for the node, compare with the annotation already associated with the block. If it is different, overwrite the same with the new annotation. For every element under that node, check whether it is already present in the data model. If it is not present, create a field for the element. In case there are any attributes defined with the element like data type, data length, minimum occurrences, maximum occurrences, enumeration values, annotation, default value, etc., associate those attributes with the field. If the field is not present, then compare the latest attributes of the element with the existing attributes and update the values wherever applicable. After processing all elements of the node, check whether there are any elements that are currently present in the data model and not available in the latest format. Remove all such fields and propagate the deletion to the presentation model as well.

Once all nodes are processed, check whether there are any additional nodes in the screen that are no longer present in the new service definition. Remove all such nodes along with their elements and propagate the deletion to the presentation model as well.

Once the business model is updated (step 304), the tool will then update all presentation models created for the screen (step 306). The following rules are used while updating the presentation model.

Create a field group for every new node. This field group consists of all elements under that node and each element display type is chosen as Text Box, List Item, Check Box, etc., based on the element properties. In case a node can have only one record, then define the view property of the corresponding field group as form so that all elements are shown in a single record format. In case a node can have multiple records, then define the view property of the corresponding field group as grid, so that records are shown in multi-record tabular form. If there is a master-detail relation with another node, then define that relation between the corresponding field groups.

For newly added fields in existing nodes, include them in the relevant field group provided there is only one field group for that node. In case a field group has multiple nodes, do not add them as the selection of relevant field group should be done by the developer in such cases.

In case the screen is based on multiple services, the above procedure is repeated (YES, step 308) until all modified services are imported into the screen. After that, the business model and the presentation model are used to create a Hyper Text Markup Language (HTML) page, a JSON file, and a JavaScript (JS) file. The HTML page is created based on HTML5 standards and it contains all presentation related attributes of the screen. The JSON file includes the hierarchy definition of various nodes and these details will be used to retrieve data from the screen and render data received from the back-end service. The JS file provides the developer an option to include functions that can be invoked when a specific action is performed on the screen. This JS file is created for the first time when a screen is created. After that, any changes are done directly in the JS file and it is not regenerated by the tool. The HTML file will have a provision to include external files such as jquery-mobile java script, and jquery-mobile Cascading Style Sheet (CSS), as well as other java script and CSS files for maximum flexibility in screen definition.

Once the business model and all available presentation models are updated, the development environment displays the layout to the developer and allows modifications (steps 310, 312, 314, 316). As part of the modifications, the user is provided with a number of options as explained below.

Change field display view property.

Change field group display view property.

Define number validations, string validations, and list validations.

Bind a function at element level event.

Bind a function at screen level event.

Rearrange the sequence of field groups.

Rearrange the order of elements.

Create new windows that can be accessed as part of the drill-down operation.

Create new control elements.

Hide existing elements.

Once the modifications are completed, the tool stores the business model and the presentation model in Extensible Markup Language (XML) format (step 318). This XML will act as the source file and can be loaded into the tool at a later time to incorporate further changes, if required.

Apart from the above options, the tool also provides an option to define a completely different layout which can be used for specific mobile form factors. In such cases, the tool will generate as many HTML files as the number of layouts. However, JSON and JS files will remain the same as the business model remains unchanged. HTML, JSON, and JS files are generated (step 320), and depending on the target mobile platform, the relevant HTML file along with the common JSON and JS file can be packaged and deployed.

### Data Exchange Between the Screen and Back-End Service

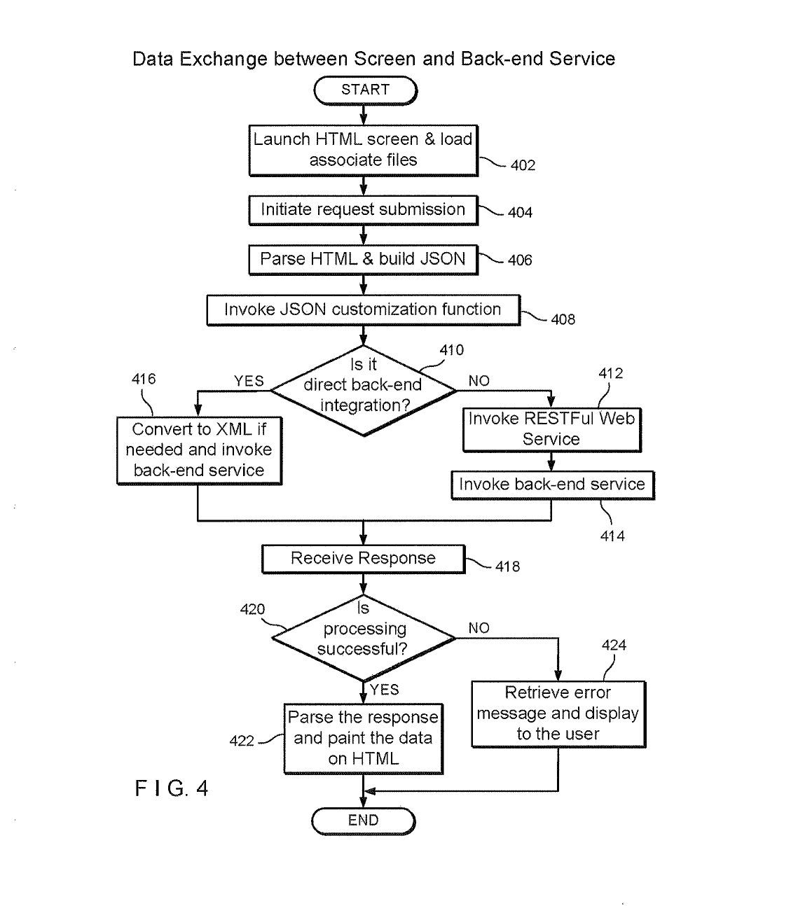

The present invention includes a Container App Component. The container app facilitates addition of new screens into a mobile app and enables data exchange between the mobile tier and the application server tier. This container app component will be specific to each mobile platform as shown in the flowchart in FIG. 4. The container app component can be a module located in, e.g., the Application Tier of FIG. 6.

The container app component includes a menu screen which will provide various display options such as link list view, button/icon view, tile view, carousel view, etc. It is built based on static data maintained in a data store or XML file. When a new screen is built, the new screen file name can be added to the static data, and after that the new screen option will automatically appear in the menu page.

Whenever any function is chosen on the menu page, it will load the HTML, JSON and JS files associated with that function (step 402). In case any JS and CSS files are included in the HTML file, those files will also get loaded, and the HTML is shown to the user.

Once the screen is launched, depending on events defined in the screen, it will either accept input from the user before sending a request to the back-end or it will directly send a request to the back-end as soon as it is launched (step 404). This request can be created using, e.g., a generic java script included in the container app. This java script file reads the JSON file associated with the screen to understand the business model of the screen and extracts the data from HTML file.

The following options are provided to connect to the back-end service.

Indirect Invocation: In this, it will build a data JSON request (step 406), append a control header, and invoke a RESTFul Web Service deployed in the app server (step 412) using, e.g., JQuery AJAX call (or in another embodiment submit it to the app server component using HTTP POST method). The control header will contain information about the screen, user, action, etc., and will be used to validate the request in the back-end (step 414). In case the developer wants to modify the JSON being submitted to the back-end, a function can be included in the screen specific JS file and required assignments and modifications can be done to the data JSON (step 408). The RESTFul Web Service will in turn call the back-end service associated with the screen. This back-end service can be a SOAP Web Service, a RESTFul Web Service, an Enterprise Java Bean (EJB), a Servlet, or a Java Messaging System (JMS). In case the message format is XML, then the JSON will be converted into XML using a Jersey parser and submitted. Once a response is received, it will forward to the front-end. It will convert from XML to JSON, if required.

Direct Invocation: This can be done (YES of step 410) in case the back-end service is RESTFul Web Service, SOAP Web Service, or a Servlet. In case the message format is XML, then JSON is converted into XML using a DOM Parser (step 416). After that, the underlying service is directly invoked.

Upon the receipt of a response from the app server component (step 418), the status will be validated. In the event that the status is “successful” (YES, step 420), the response is stored in an object variable and the relevant fields in HTML file are populated by reading that object (step 422). In the event the status is “failure” (NO, step 420), then error messages are extracted from the response and shown to the user (step 424).

In case a screen is built based on multiple services, the above procedure is repeated till all services are invoked. The final response is considered as ‘success’ only when all individual responses associated with the screen are successful. In case the final response is ‘failure’ and any of the underlying service involves transaction processing, then a compensating service is invoked before sending the final response. For this, the compensating service details are captured in the development environment at the time of screen definition.

Once data is retrieved and ready to be rendered, it is possible that pagination is enabled in some multi-record grids present in the HTML file. In such cases, the response builder function renders the data partially as per the pagination limit so that the rendering performance is not adversely affected. Similarly, in the case of master-detail-detail relations, the records in the second child should be shown based on the current record in the first child. In such cases, the function will only paint that data corresponding to the record currently shown in the first level detail. Whenever the current record in the first level child is changed, the response builder function will fetch the relevant data of the second level child and display.

### App Server Component

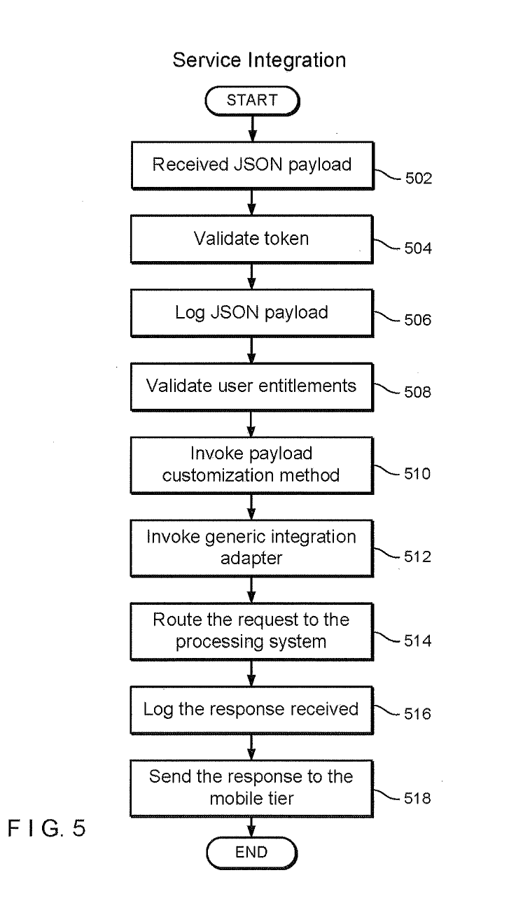

The App Server Component of the present application is responsible for receiving the request from the mobile tier and sending a response to the mobile tier as explained in the flowchart of FIG. 5. The App Server Component can be a module located in, e.g., the Application Tier of FIG. 6.

This component includes a gamut of RESTful web services to cater to the various functionalities offered by screens deployed in the mobile tier. The services are generated by the development tool as part of the screen design. They are constructed as extensible java components. A base method receives the message and an extended class implements deployment-specific processing of the payload.

The services will receive a JSON payload via a HTTP POST method call from the mobile channel (step 502). This JSON object comprises a header and a body. The following actions are performed on the object.

The session authenticity is validated using a token generated in its earlier HTTP call (step 504). The request for subsequent auditing purposes is logged (step 506). User entitlements are validated by calling the relevant authentication service (step 508). The A payload customization method is invoked (step 510). The service invokes a generic integration adapter (step 512), which, based on the meta data maintained for the function, will route the request to the appropriate processing system in the enterprise (step 514). The service then waits for a response from the relevant processing system (step 516). Upon receipt, the transaction audit trail is further updated and the response is forwarded to the mobile tier (step 518).

### Example Implementation(s)

The present invention or any part(s) or function(s) thereof, including, e.g., the development tool, the new mash-up screen development tool, the automatic screen upgrade component, the container app component, and the app server component, may be implemented using hardware, software, or a combination thereof, including, e.g., Java Swing, and may be implemented in one or more computer systems or other processing systems. A computer system for performing the operations of the present invention and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the invention using other computer systems and/or architectures.

The computer system can include a display interface that forwards graphics, text, and other data from the communication infrastructure (or from a frame buffer) for display on a display unit. The display interface can communicate with a browser. The computer system also includes a main memory, preferably a random access memory, and may also include a secondary memory and a database. The secondary memory may include, for example, a hard disk drive and/or a removable storage drive, representing a floppy disk drive, a magnetic tape drive, an optical disk drive, etc. The removable storage drive reads from and/or writes to a removable storage unit in a well known manner. The removable storage unit can represent a floppy disk, magnetic tape, optical disk, etc. which is read by and written to by the removable storage drive. As will be appreciated, the removable storage unit can include a computer usable storage medium having stored therein computer software and/or data.

The computer system may also include a communications interface which allows software and data to be transferred between the computer system and external devices. The terms “computer program medium” and “computer usable medium” are used to refer generally to media such as the removable storage drive, a hard disk installed in the hard disk drive, and signals. These computer program products provide software to the computer system.

Computer programs or control logic are stored in the main memory and/or the secondary memory. Computer programs may also be received via the communications interface. Such computer programs or control logic (software), when executed, cause the computer system or its processor to perform the features and functions of the present invention, as discussed herein.

Accordingly, the systems and methods of the present invention can be implemented on, e.g., a computer having at least one processor and a memory coupled to the processor.

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the Figures illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the Abstract provided herein is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

What is claimed is:

1. A method for enabling screen development based on a back-end service, the method comprising the steps of:
importing a message format definition associated with the back-end service;
creating a business model;
creating a presentation model;
modifying the business model if changes are required;
modifying the presentation model if changes are required;
storing the business model and the presentation model in XML format as a source file; and
generating, using the business model and the presentation model, a HTML page, JSON file, and a JS file.

2. The method of claim 1, wherein the message format definition is one of WSDL, XSD, and JSON.

3. The method of claim 1, wherein the step of creating the business model comprises:
creating a block for every node in the message format definition; and
creating a field for every element in the message format definition.

4. The method of claim 1, wherein the step of creating the presentation model comprises:
creating a default window for displaying all nodes and elements;
creating a field group for each node;
in a case in which a node can have only one record, defining a view property of the corresponding field group as form to show all elements in a single record format; and
in a case in which a node can have multiple records, define the view property of the corresponding field group as a grid to show records in multi-record tabular form.

5. The method of claim 1, wherein:
the HTML page contains presentation-related attributes of the screen;
the JSON file includes a hierarchy definition of various nodes for use in retrieving data from the screen and rendering data received from the back-end service; and
the JS file provides a developer with an option to include functions that can be invoked when a specific action is performed on the screen.

6. The method of claim 1, further comprising the step of checking whether there is an additional service, and, if so:
importing a format definition associated with the additional service;
adding to the business model by (1) creating a block for every node in the message format definition associated with the additional service and associating the block with the additional service, and (2) creating a field for every element in the message format definition associated with the additional service; and
adding to the presentation model by creating a field group for each node in the message format definition associated with the additional service, and in a case in which a node can have only one record, defining a view property of the corresponding field group as form to show all elements in a single record format, and in a case in which a node can have multiple records, defining the view property of the corresponding field group as a grid to show records in multi-record tabular form.

7. A non-transitory computer-readable medium storing a program, which, when executed by at least one processor, causes the at least one processor to perform the method for enabling screen development based on a back-end service according to claim 1.

8. A method for providing a development environment to automatically upgrade a screen whenever an underlying service is modified, the method comprising the steps of:
importing a latest message format definition associated with a back-end service;
updating an existing business model;
updating an existing presentation model;
repeating the importing and updating steps for each service associated with the screen;
modifying the business model if changes are required;
modifying the presentation model if changes are required;
storing the business model and the presentation model in XML format as a source file; and
generating, using the business model and the presentation model, a HTML page, JSON file, and a JS file.

9. The method of claim 8, wherein the message format definition is one of WSDL, XSD, and JSON.

10. The method of claim 8, wherein the step of updating the existing business model includes:
verifying, for every node in the message format definition, whether the node is already present in the current data model under the same service;
if the node is not present, creating a block for that node, associating the block with the service, and creating a field for every element in the message format definition;
if the node is already present, (1) verifying whether there is any change required in the master-detail relation for the node, and if so updating the existing master-details relation, (2) checking for every element under the node whether the element is already present in the data model, (3) creating a field for each element not present, and (4) checking whether any elements currently present in the data model are not available in the latest format and removing all such fields in both the business model and the presentation model.

11. The method of claim 8, wherein the step of updating the existing presentation model includes:
creating a field group for each new node comprising all elements under the node, and in a case in which a node can have only one record, defining a view property of the corresponding field group as form to show all elements in a single record format, and in a case in which a node can have multiple records, defining the view property of the corresponding field group as a grid to show records in multi-record tabular form, and
including newly added fields in existing nodes if there is only one field group for the node.

12. The method of claim 8, wherein:
the HTML page contains presentation-related attributes of the screen;
the JSON file includes a hierarchy definition of various nodes for use in retrieving data from the screen and rendering data received from the back-end service; and
the JS file provides a developer with an option to include functions that can be invoked when a specific action is performed on the screen.

13. A non-transitory computer-readable medium storing a program, which, when executed by at least one processor, causes the at least one processor to perform the method for providing a development environment to automatically upgrade a screen whenever an underlying service is modified according to claim 8.

14. A method for facilitating addition of new screens into a mobile app and providing data exchange between a screen and a back-end service, the method comprising the steps of:
launching a HTML screen and loading HTML, JSON, and JS files associated with a chosen function;
initiating a request submission to the back-end;
if indirect back-end integration, building a data JSON request invoking a RESTFul web service deployed in the application server, and invoking the back-end service;
if direct back-end integration, converting JSON to XML if the message format of the back-end service is XML, and invoking the back-end service;
validating the status as successful if a response from the application server component is received, storing the response in an object variable, and populating relevant fields in the HTML file by reading the object variable, and
retrieving error messages and displaying the error messages to the user if the status is not successful.

15. The method of claim 14, further comprising the step in indirect back-end integration of including a function in the screen-specific JS file such that a developer can modify the JSON file being submitted to the back-end.

16. A non-transitory computer-readable medium storing a program, which, when executed by at least one processor, causes the at least one processor to perform the method for facilitating addition of new screens into a mobile app and providing data exchange between a screen and a back-end service according to claim 14.

17. A method for receiving a request from a mobile tier and sending a response to the mobile tier, the method comprising the steps of:
receiving a JSON object via a HTTP POST method call from a mobile channel;
performing the following actions on the JSON object:
validating session authenticity using a token generated in an earlier HTTP call;
logging the JSON object;
validating user entitlements;
invoking a generic integration adapter to route the request to an appropriate processing system;
logging a response received from the appropriate processing system;
further updating the transaction audit trail; and
forwarding the response to the mobile tier.

18. A non-transitory computer-readable medium storing a program, which, when executed by at least one processor, causes the at least one processor to perform the method for receiving a request from a mobile tier and sending a response to the mobile tier according to claim 17.

19. A system implemented on a computer having a processor and a memory coupled to said processor for automatic generation of screens for mobile apps based on back-end services, comprising:
a Development Tool Module for enabling screen development based on the back-end service;
a Mash-Up Module for adding an additional service;
an Automatic Screen Upgrade Module for providing a development environment to automatically upgrade a screen whenever an underlying service is modified;
a Container App Module for facilitating addition of new screens into a mobile app and providing data exchange between the screen and the back-end service; and
an App Server Module for receiving a request from a mobile tier and sending a response to the mobile tier.

20. A system for enabling screen development based on a back-end service, the system comprising:
a development tool, adapted to:
import a message format definition associated with the back-end service;
create a business model;
create a presentation model;
modify the business model if changes are required;
modify the presentation model if changes are required;
store the business model and the presentation model in XML format as a source file; and
generate, using the business model and the presentation model, a HTML page, JSON file, and a JS file.

21. A system for providing a development environment to automatically upgrade a screen whenever an underlying service is modified, the system comprising:
an automatic upgrade tool, adapted to:
import a latest message format definition associated with a back-end service;
update an existing business model;
update an existing presentation model;
repeat the importing and updating steps for each service associated with the screen;
modify the business model if changes are required;
modify the presentation model if changes are required;
store the business model and the presentation model in XML format as a source file; and
generate, using the business model and the presentation model, a HTML page, JSON file, and a JS file.

22. A system for facilitating addition of new screens into a mobile app and providing data exchange between a screen and a back-end service, the system comprising:
a Container App, adapted to:
launch a HTML screen and loading HTML, JSON, and JS files associated with a chosen function;
initiate a request submission to the back-end;
if indirect back-end integration, build a data JSON request invoking a RESTFul web service deployed in the application server, and invoking the back-end service;
if direct back-end integration, convert JSON to XML if the message format of the back-end service is XML, and invoking the back-end service;
validate the status as successful if a response from the application server component is received, store the response in an object variable, and populate relevant fields in the HTML file by reading the object variable, and
retrieve error messages and display the error messages to the user if the status is not successful.

23. A system for receiving a request from a mobile tier and sending a response to the mobile tier, the system comprising:
an App Server, adapted to:
receive a JSON object via a HTTP POST method call from a mobile channel;
perform the following actions on the JSON object:
validate session authenticity using a token generated in an earlier HTTP call;
log the JSON object;
validate user entitlements;
invoke a generic integration adapter to route the request to an appropriate processing system;
log a response received from the appropriate processing system;
further update the transaction audit trail; and
forward the response to the mobile tier.
